(19) United States
(12) Patent Application Publication
(10) Pub. No.: US 2005/0213031 A1
(43) Pub. Date: Sep. 29, 2005

(54) METHOD FOR DETERMINING CORNEAL CHARACTERISTICS USED IN THE DESIGN OF A LENS FOR CORNEAL RESHAPING

(76) Inventor: William E. Meyers, Scottsdale, AZ (US)

Correspondence Address: SNELL & WILMER;ONE ARIZONA CENTER, 400 EAST VAN BUREN, PHOENIX, AZ, 850040001, US

(21) Appl. No.: 10/906,603

(22) Filed: Feb. 25, 2005

Related U.S. Application Data
(60) Provisional application No. 60/547,859, filed on Feb. 25, 2004.

(51) Int. Cl. G02C 7/02

(52) U.S. Cl. 351/167

(57) ABSTRACT

The present invention provides methods for measuring corneal characteristics and distortions to determine one or more appropriate designs for one or more corrective lenses used to reshape the cornea of an eye. The method includes measuring and/or mapping the topology of the cornea, identifying a desired new shape for the cornea, comparing the current shape of the cornea to the desired shape, and configuring one or more corrective lenses to apply force to the cornea to change its shape. The process of measuring and/or mapping, comparing, and configuring may be repeated until the cornea takes on the desired shape.

### CROSS-REFERENCE TO RELATED APPLICATIONS

This application claims priority to U.S. Provisional Application No. 60/547,859 filed Feb. 25, 2004,provisional application, in its entirety, is hereby incorporated by reference.

### FIELD OF INVENTION

The invention generally relates to contact lenses, and particularly to, methods for measuring corneal characteristics and distortions for purposes of determining the design of a corrective lens for reshaping the cornea of an eye.

### BACKGROUND OF INVENTION

In the treatment of visual acuity deficiencies, correction by means of eyeglasses or contact lenses is used by a large percentage of the population. Such visual acuity deficiencies include hyperopia or far-sightedness, myopia or near-sightedness, astigmatisms (caused by asymmetry of a patient's eye), and presbyopia (caused by loss of accommodation by the crystalline lens). To alleviate the burden of wearing eyeglasses and/or contact lenses, surgical techniques have been developed for altering the shape of a patient's cornea in an attempt to correct refractive errors of the eye. Such surgical techniques include photorefractive keratectomy (PRK), LASIK (laser-assisted in-situ keratomileusis), as well as procedures such as automated lamellar keratoplasty (ALK) or implanted corneal rings, implanted contact lenses, and radial keratotomy (RK). These procedures are intended to surgically modify the curvature of the cornea to reduce or eliminate visual defects. The popularity of such techniques has increased greatly, but such techniques still carry risk in both the procedures themselves, as well as post-surgical complications.

Alternatives to permanent surgical procedures to alter the shape of the cornea include corneal refractive therapy (CRT) and orthokeratology (also known as “ortho-K”), in which a modified contact lens is applied to the eye to alter the shape or curvature of the cornea by compression of the corneal surface imparted by the corrective lens.

### SUMMARY OF INVENTION

While the way in which the present invention addresses the disadvantages of the prior art will be discussed in greater detail below, in general, the present invention provides methods for measuring corneal characteristics and distortions for designing a corrective lens to be worn for specified periods of time, wherein the corrective lens, by using various by topographic measurements, uses localized forces applied to various locations on the cornea to change the shape of the cornea. Additionally, the present invention allows the measurement of regression from the changed shape to the original shape and/or some other shape.

### DETAILED DESCRIPTION

The following description is of exemplary embodiments of the invention only, and is not intended to limit the scope, applicability or configuration of the invention in any way. Rather, the following description is intended to provide a convenient illustration for implementing various embodiments of the invention. As will become apparent, various changes may be made in the function and arrangement of the elements described in these embodiments without departing from the scope of the invention as set forth in the appended claims.

That said, in general, the present invention provides methods for taking measurements of the characteristics of the cornea of an eye for use in designing a corrective lens that uses localized forces applied to various locations on the cornea to change the shape of the cornea, and for measuring the resulting corneal distortions by topographic means. Additionally, the present invention allows for the measurement of changes to the shape of the cornea. Further still, the present invention allows information to be obtained relating to various forces that may be encountered under the eyelid(s) of a patient, therefore allowing potential development of age, gender and racially consistent components for use in later, similar treatments. Additionally, in various embodiments, the information generated is gathered and isolated by measuring the various characteristics independently from the one another. The resulting data may additionally be used to predict a particular lens design which is optimized to achieve a desired shape.

Briefly, the present invention is particularly useful in the field of corneal reshaping to improve deficiencies in eyesight relating to conditions such as myopia (near-sightedness), hyperopia (far-sightedness), presbyopia (gradual loss of the eye's ability to change focus for seeing near objects caused because of the lens becoming less elastic), astigmatism (distorted vision), and other such conditions caused by refractive errors in the eye. For proper eyesight, the cornea (i.e., the clear window in front of the eye) and the lens (located behind the pupil) must properly focus or “refract” light onto the retina (located at the back of the eye). If the length or shape of the eye is not ideal, the light may get focused too early or too late leaving a blurred image on the retina. In the case of myopia, the cornea is elongated, whereas in the case of hyperopia, the cornea is shortened.

For example, in various applications, the cornea of an eye may be reshaped using various specifically shaped contact lenses to compensate for the elongation, shortness, and/or other irregularities of the cornea. Such reshaping may be generally referred to herein as corneal refractive therapy or “CRT.” For example, it has been found that corrective lenses can be designed to exert varying degrees of pressure on different areas of the cornea by, for example, varying the shape and thickness of various portions of the lens. Preferably, the shape of the corrective lens is determined based on the initial shape of the cornea. Such design requires mapping of a cornea prior to, during, and/or after treatment with such lenses. The present invention provides methods for measuring the “topography” of the cornea at such various times.

Further still, the present invention finds use in connection with soft lens corneal reshaping. Unlike rigid lenses which hold their shape despite forces arising between the eyelid and the cornea, soft lenses tend to partially conform to the shape imposed by various other impinging forces. Experience from rigid lens corneal reshaping suggests that not all corneas are alike in their resistance to reshaping forces, and may vary either from eye to eye, across the surface of the eye, or from the center to the periphery of a single cornea. Thus, it is desirable to customize the shape of a soft lens placed in an eye such that the sum of the forces altering the shape of the cornea and the forces from the soft lens will be appropriate to achieve a final desired corneal shape.

In one embodiment, after a first period of exposure to a diagnostic or “test” lens, a diagnostic map of the reshaped cornea is taken and a difference map is computed illustrating the changes from the original, pre-exposure shape to its current shape. In another embodiment, a corrective lens is then fabricated based on the difference map. In accordance with one aspect of an exemplary embodiment of the present invention, the corrective lens is comprised of a soft lens material. Accordingly, various embodiments of the present invention provide data relating to the distribution of variations in resistance relating to designing soft lenses for corneal reshaping.

More particularly now, in accordance with one exemplary embodiment of the present invention, the corneal impact of various forces such as lid pressure, fluidics (post lens tear pressure), mechanical forces transferred to the cornea by the inelasticity of the lens matrix, and combinations thereof, are measured. In various embodiments of the present invention, a suitable test lens or lens-like ophthalmically compatible material of predetermined shape is placed between the lid and the cornea, and various now known or as yet unknown topographic measuring instruments are used to measure and/or observe the topography of the cornea over time (e.g., before, during, and after treatment with corneal shaping lenses). Additionally, in accordance with another aspect of the present invention, various measurements suitably are made by analyzing any changes in shape to the test lens (or similar object) while it is in contact with the cornea. These measurements thus provide the ability to track characteristics of the cornea, thereby facilitating an optimal design of a corrective lens to achieve a desired corneal shape.

In accordance with various other embodiments of the present invention, various measurement features are provided on the test lens to improve or facilitate corneal/lens measurement data. Various non-limiting examples of such measurement features include rounded bumps or divots on the anterior and/or posterior test lens surface, rings of raised or depressed shape on the anterior and/or posterior lens surface(s), or any other feature now known or as yet unknown whose impact on the corneal surface suitably provides information relating to the deformability of the lens under similar conditions. In accordance with embodiments of the invention having measurement features, the effects of the presence of the features may be suitably monitored by various known or currently unknown equipment such as, for example, topographers, keratometers, and/or fluorescein instilled in the eye.

In accordance with various exemplary embodiments of the invention that incorporate measurement features, independent data on the effects of various forces on the cornea may be obtained by direct application without eyelid involvement or interference. For example, conventional tonometers are known to leave impressions on corneal surfaces after even very brief exposure to the cornea, and thus, the force applied can be measured and appropriately adjusted. Furthermore, conventional tonometers also allow such force to be pulsed repeatedly or applied constantly, depending on the nature of the data desired. Such measurements can thus be observed with or without concomitant “object impression” data to estimate the geometry necessary for desired corneal reshaping.

Additionally, in accordance with various additional aspects of the present invention, by comparing the relative dimensions of an impression to that of the measurement feature that created it, a relationship can be drawn−such as, for example, through finite element analysis and/or other mathematical and engineering techniques−that will guide the design of similar reshaping corrective lenses. For example, it often is desirable to exaggerate the features, shapes, and/or regional thicknesses of the lens, as the resultant reshaping of the cornea tends to be a “diminished”or subdued version of the shape of the corrective lens.

Additionally, various measures to facilitate consistent placement of the test lens on the cornea for accurate diagnostic measurements may be used in accordance with various exemplary aspects of the present invention, and particularly with respect to the measurement of features of the lens that are intended to cause corneal deformation. For example, depending on the nature of the test lens and the measurements desired, one skilled in the art will appreciate that such measurements may be facilitated by partially or completely anesthetizing the cornea. Alternatively, in accordance with other aspects of the present invention, the test lens may comprise features that are independent of location on the cornea (such as, for example, rings, dimples and/or other raised or indented features), and/or have the above-described structures, arrangements, proportions, elements, materials, and components used in the practice of the invention. In addition to those not specifically described, other structures, arrangements, proportions, elements, materials, and components may be used and particularly adapted to specific users and their requirements without departing from the spirit and scope of the present invention.

1. A method for treating a visual acuity deficiency, comprising the steps of:
measuring a first topology of a cornea of an eye;
identifying a desired final shape of said cornea;
reshaping said cornea utilizing a test lens placed on said cornea, wherein said reshaping creates a second topology of said cornea;
measuring said second topology;
designing a corrective lens using said first topology and said second topology measurements; and
reshaping said cornea to achieve a desired final shape utilizing said corrective lens placed on said cornea.

2. The method of claim 1, further comprising:
continuing a sequence of measuring the topology of said cornea and reshaping said cornea until said desired final shape is achieved.

3. The method of claim 1, further comprising:
measuring said cornea after said desired final shape is achieved to determine an amount of regression from said desired final shape.

4. The method of claim 1, wherein said measuring said first topology step comprises the step of:
measuring at least two characteristics of said cornea, wherein each characteristic is measured independent of each other.

5. The method of claim 4, wherein said measuring said second topology step comprises the step of:
re-measuring at least one of said two characteristics, wherein each characteristic is measured independent of each other when two or more characteristics are re-measured.

6. The method of claim 1, wherein at least one of said reshaping steps comprises the step of:
reshaping said cornea utilizing a soft corrective lens placed on said cornea.

7. The method of claim 1, wherein said step of reshaping said cornea utilizing a test lens comprises utilizing a tests lens having a raised feature.

8. The method of claim 7, wherein said step of reshaping said cornea utilizing a test lens comprises utilizing a tests lens having at least one of a ring, a dimple, and a bump.

9. The method of claim 1, wherein the measuring said second topology step comprises the step of:
measuring said second topology while said test lens is on said cornea.

10. The method of claim 1, further comprising the step of:
mapping a difference between said first topology and said second topology.

11. The method of claim 1, further comprising the step of:
obtaining information related to at least one localized force on said cornea utilizing a test lens.

12. The method of claim 11, wherein said obtaining step comprises the step of:
obtaining information related to at least one of a fluid force of said eye, an eye lid force, and a mechanical force transferred to said cornea from at least one of said test lens and said corrective lens.

13. The method of claim 11, wherein said obtaining step comprises the step of:
providing information to allow development of at least one of age, gender, and racially consistent corrective lenses.
